(19) United States
(12) Patent Application Publication
(10) Pub. No.: US 2013/0088474 A1
(43) Pub. Date: Apr. 11, 2013

(54) LIGHT-EMITTING COMPONENT DRIVING CIRCUIT AND RELATED PIXEL CIRCUIT AND APPLICATIONS USING THE SAME

(71) Applicants: Wen-Chun Wang, Taichung City (TW); Hsi-Rong Han, Taichung City (TW); Wen-Tui Liao, Taichung City (TW); Chih-Hung Huang, Taichung City (TW); Tsung-Yu Wang, Taichung City (TW)

(72) Inventors: Wen-Chun Wang, Taichung City (TW); Hsi-Rong Han, Taichung City (TW); Wen-Tui Liao, Taichung City (TW); Chih-Hung Huang, Taichung City (TW); Tsung-Yu Wang, Taichung City (TW)

(21) Appl. No.: 13/645,441

(22) Filed: Oct. 4, 2012

(30) Foreign Application Priority Data
Oct. 5, 2011 (TW) 100135995
Mar. 28, 2012 (TW) 101110776
May 11, 2012 (TW) 101116934

(51) Int. Cl. H05B 37/02; G09G 3/30; G06F 3/038

(52) U.S. Cl. 345/211; 315/291; 345/76

(57) ABSTRACT

A pixel circuit related to an organic light emitting diode (OLED) is provided, and if a circuit configuration (5T1C) thereof collocates with suitable operation waveforms, a current flowing through an OLED in the OLED pixel circuit is not varied along with a threshold voltage (Vth) shift of a TFT used for driving the OLED. Accordingly, the brightness uniformity of the applied OLED display is substantially improved.

### CROSS-REFERENCE TO RELATED APPLICATION

This application claims the priority benefits of Taiwan application serial no. 100135995, filed on Oct. 5, 2011, Taiwan application serial no. 101110776, filed on Mar. 28, 2012, and Taiwan application serial no. 101116934, filed on May 11, 2012. The entirety of each of the above-mentioned patent applications is hereby incorporated by reference herein and made a part of specification.

### BACKGROUND OF THE INVENTION

1. Field of the Invention

The invention relates to a flat panel display technique. Particularly, the invention relates to a driving circuit for a light-emitting component (for example, organic light-emitting diode (OLED), though the invention is not limited thereto) having a self-luminous characteristic and a related pixel circuit and applications using the same.

2. Description of Related Art

Along with rapid development of multimedia society, techniques in semiconductor components and display devices are also quickly developed. Regarding the display devices, since an active matrix organic light-emitting diode (AMOLED) display has advantages of no viewing-angle limitation, low manufacturing cost, a high response speed (approximately a hundred times faster than that of a liquid crystal display (LCD)), power saving, self-luminous, direct current (DC) driving suitable for portable applications, a large range of operating temperature, light weight and capable of being miniaturized and thinned along with hardware equipment, etc, it complies with a display requirement of a multimedia age. Therefore, the AMOLED display has a great development potential to become a novel flat panel display of a next generation, and can be used to replace the LCD.

Presently, there are two methods to fabricate an AMOLED display panel, one method is to fabricate by using a low temperature polysilicon (LTPS) thin-film transistor (TFT) process technique, and another method is to fabricate by using an a-Si TFT process technique. Since the LTPS TFT process technique requires more optical mask processes, a fabrication cost thereof is increased. Therefore, the current LTPS TFT process technique is mainly applied on middle and small size panels, and the a-Si TFT process technique is mainly applied on large size panels.

Generally, regarding the AMOLED display panel fabricated according to the LTPS TFT process technique, a TFT in a pixel circuit thereof can be a P type or an N type, however, since the P-type TFT has better driving capability in conduction of a positive voltage, the P-type TFT is generally used for implementation. However, under the condition that the P-type TFTs are used to implement the OLED pixel circuit, a current flowing through the OLED would be varied (or different) along with a threshold voltage (Vth) shift of the TFT used for driving the OLED. Therefore, brightness uniformity of the OLED display is influenced.

### SUMMARY OF THE INVENTION

Accordingly, in order to enhance brightness uniformity of an organic light-emitting diode (OLED) display, an exemplary embodiment of the invention provides a light-emitting component driving circuit including a power unit, a driving unit and a data storage unit. The power unit receives a (fixed) power supply voltage, and conducts the power supply voltage in response to a light enable signal in a light enable phase. The driving unit is coupled between the power unit and a first end of the light-emitting component, and includes a driving transistor coupled to the first end of the light-emitting component, where a second end of the light-emitting component receives the light enable signal. The driving unit controls a driving current flowing through the light-emitting component in the light enable phase.

The data storage unit includes a storage capacitor, and is configured to store a data voltage (Vdata) and a threshold voltage (Vth) related to the driving transistor through the storage capacitor in a data-writing phase. In the light enable phase, the driving unit generates the driving current flowing through the light-emitting component in response to a cross-voltage of the storage capacitor, where the driving current flowing through the light-emitting component is not influenced by the threshold voltage of the driving transistor.

In an exemplary embodiment of the invention, the power unit includes a power conduction transistor, where a source thereof receives the power supply voltage, and a gate thereof receives the light enable signal.

In an exemplary embodiment of the invention, a first drain/source of the driving transistor is coupled to a drain of the power conduction transistor, a second drain/source of the driving transistor is coupled to the first end of the light-emitting component, and a gate of the driving transistor is coupled to a first end of the storage capacitor. Moreover, a second end of the storage capacitor is coupled to one of the power supply voltage and a (fixed) reference voltage.

In an exemplary embodiment of the invention, the data storage unit further includes a writing transistor and a collection transistor. A gate of the writing transistor receives a writing scan signal, a drain of the writing transistor receives the data voltage, and a source of the writing transistor is coupled to the second drain/source of the driving transistor and the first end of the light-emitting component (alternatively, the source of the writing transistor is coupled to the first drain/source of the driving transistor and the drain of the power conduction transistor). A gate of the collection transistor receives the writing scan signal, a source of the collection transistor is coupled to the gate of the driving transistor and the first end of the storage capacitor, and a drain of the collection transistor is coupled to the first drain/source of the driving transistor and the drain of the power conduction transistor (alternatively, the drain of the collection transistor is coupled to the second drain/source of the driving transistor and the first end of the light-emitting component). The light-emitting component may be an OLED, and the first end of the light-emitting component is an anode of the OLED, and the second end of the light-emitting component is a cathode of the OLED.

In an exemplary embodiment of the invention, the data storage unit initializes the storage capacitor in response to a reset scan signal in a reset phase. In this case, the data storage unit further includes a reset transistor, where a gate and a source of the reset transistor are coupled with each other to receive the reset scan signal, and a drain of the reset transistor is coupled to the gate of the driving transistor, the source of the collection transistor and the first end of the storage capacitor.

In an exemplary embodiment of the invention, the driving transistor, the power conduction transistor, the writing transistor, the collection transistor and the reset transistor are all P-type transistors.

In an exemplary embodiment of the invention, the light-emitting component driving circuit is an OLED driving circuit, and the OLED driving circuit sequentially enters the reset phase, the data-writing phase and the light enable phase.

In an exemplary embodiment of the invention, in the reset phase, the reset scan signal is enabled, and the writing scan signal and the light enable signal are disabled. In the data-writing phase, the writing scan signal is enabled, and the reset scan signal and the light enable signal are disabled. In the light enable phase, the light enable signal is enabled, and the reset scan signal and the writing scan signal are disabled.

On the other hand, another exemplary embodiment of the invention provides a light-emitting component driving circuit including a power unit, a driving unit and a data storage unit. The power unit receives a power supply voltage, and conducts the power supply voltage in response to a light enable signal in a light enable phase. The driving unit is coupled between the power unit and a light-emitting component, and includes a driving transistor coupled to a first end of the light-emitting component. The driving unit controls a driving current flowing through the light-emitting component in the light enable phase.

The data storage unit includes a storage capacitor, and is configured to store a data voltage (Vdata) and a threshold voltage (Vth) related to the driving transistor through the storage capacitor in a data-writing phase. In the light enable phase, the driving unit generates the driving current flowing through the light-emitting component in response to a cross-voltage of the storage capacitor, where the driving current is not influenced by the threshold voltage of the driving transistor, and an impact of the power supply voltage on the driving current can be effectively reduced/mitigated/released.

In an exemplary embodiment of the invention, a second end of the light-emitting component is coupled to a (fixed) reference voltage, and in case that the power supply voltage is a fixed power supply voltage, and the power unit may include a power conduction transistor. The source of the power conduction transistor receives the fixed power supply voltage, and a gate of the power conduction transistor receives the light enable signal.

In an exemplary embodiment of the invention, in case that the power supply voltage is the fixed power supply voltage, a first drain/source of the driving transistor is coupled to a drain of the power conduction transistor, a second drain/source of the driving transistor is coupled to the first end of the light-emitting component, and a gate of the driving transistor is coupled to a first end of the storage capacitor. Moreover, a second end of the storage capacitor is coupled to a control signal.

In an exemplary embodiment of the invention, in case that the power supply voltage is the fixed power supply voltage, the data storage unit may further include a writing transistor and a collection transistor. A gate of the writing transistor receives a writing scan signal, a drain of the writing transistor receives the data voltage, and a source of the writing transistor is coupled to the second drain/source of the driving transistor and the first end of the light-emitting component (alternatively, the source of the writing transistor is coupled to the first drain/source of the driving transistor and the drain of the power conduction transistor). A gate of the collection transistor receives the writing scan signal, a source of the collection transistor is coupled to the gate of the driving transistor and the first end of the storage capacitor, and a drain of the collection transistor is coupled to the first drain/source of the driving transistor and the drain of the power conduction transistor (alternatively, the drain of the collection transistor is coupled to the second drain/source of the driving transistor and the first end of the light-emitting component). The light-emitting component may be an OLED, and the first end of the light-emitting component is an anode of the OLED, and the second end of the light-emitting component is a cathode of the OLED. In this case, a level of the fixed reference voltage is substantially not less than a highest level of the data voltage minus a conduction voltage of the organic light-emitting diode (alternatively, a level of the fixed reference voltage is substantially not less than a highest level of the data voltage minus the threshold voltage of the driving transistor and a conduction voltage of the organic light-emitting diode).

In an exemplary embodiment of the invention, in case that the power supply voltage is the fixed power supply voltage, the data storage unit initializes the storage capacitor in response to a reset scan signal in a reset phase. In this case, the data storage unit further includes a reset transistor, where a gate and a source of the reset transistor are coupled with each other to receive the reset scan signal, and a drain of the reset transistor is coupled to the gate of the driving transistor, the source of the collection transistor and the first end of the storage capacitor.

In an exemplary embodiment of the invention, in case that the power supply voltage is the fixed power supply voltage, the driving transistor, the power conduction transistor, the writing transistor, the collection transistor and the reset transistor are all P-type transistors.

In an exemplary embodiment of the invention, the provided another light-emitting component driving circuit may be n OLED driving circuit, and the OLED driving circuit sequentially enters the reset phase, the data-writing phase and the light enable phase. In this case, in the reset phase and the data-writing phase, the control signal has a first low voltage level; and in the light enable phase, the control signal has a high voltage level. In the reset phase and the data-writing phase, the light enable signal has the high voltage level; and in the light enable phase, the light enable signal has a second low voltage level which is different from the first low voltage level. In the reset phase, the reset scan signal has the second low voltage level; and in the data-writing phase and the light enable phase, the reset scan signal has the high voltage level. In the data-writing phase, the writing scan signal has the second low voltage level; and in the reset phase and the light enable phase, the writing scan signal has the high voltage level.

Another exemplary embodiment of the invention provides a pixel circuit having the aforementioned light-emitting component driving circuit, and the provided pixel circuit may be an OLED pixel circuit.

Another exemplary embodiment of the invention provides an OLED display panel having the aforementioned OLED pixel circuit.

Another exemplary embodiment of the invention provides an OLED display having the aforementioned OLED display panel.

According to the above descriptions, the invention provides a pixel circuit related to an OLED, and when a circuit configuration (5T1C) thereof collocates with suitable operation waveforms, the current flowing through the OLED in the OLED pixel circuit is not varied along with the power supply voltage (Vdd) which is probably influenced by an IR drop, and is not varied along with the threshold voltage (Vth) shift of a TFT used for driving the OLED. Accordingly, the brightness uniformity of the applied OLED display is substantially improved.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a pixel circuit 10 according to an exemplary embodiment of the invention.

FIG. 2 is an implementation circuit diagram of the pixel circuit 10 of FIG. 1.

FIG. 3 is an operation waveform diagram of the pixel circuit 10 of FIG. 1.

FIGS. 4-6 are circuit diagrams of the pixel circuit 10 of FIG. 1 according to other embodiments of the invention.

FIG. 7 is a schematic diagram of a pixel circuit 70 according to an exemplary embodiment of the invention.

FIG. 8 is an implementation circuit diagram of the pixel circuit 70 of FIG. 7.

FIG. 9 is an operation waveform diagram of the pixel circuit 70 of FIG. 7.

FIG. 10 is a circuit diagram of the pixel circuit 70 of FIG. 7 according to another embodiment of the invention.

### DETAILED DESCRIPTION OF DISCLOSED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

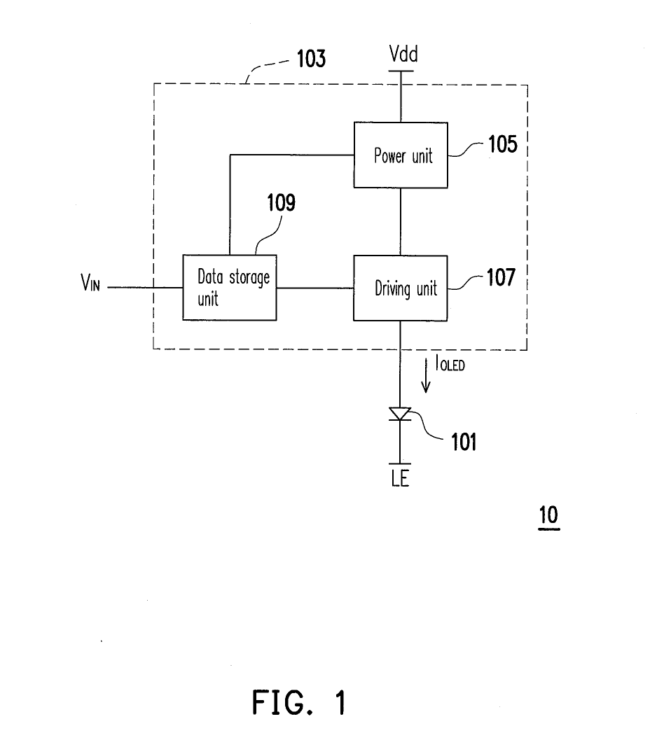

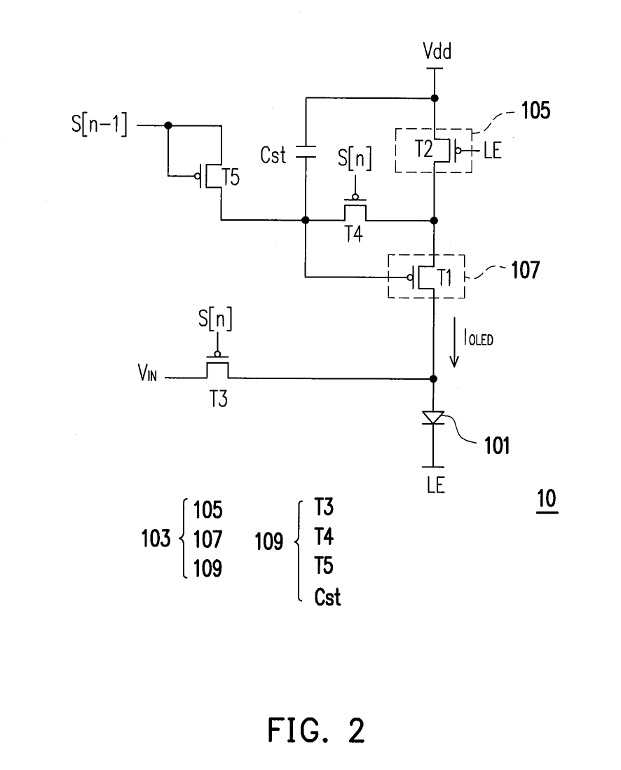

FIG. 1 is a schematic diagram of a pixel circuit 10 according to an exemplary embodiment of the invention, and FIG. 2 is an implementation circuit diagram of the pixel circuit 10 of FIG. 1. Referring to FIG. 1 and FIG. 2, the pixel circuit 10 of the present exemplary embodiment includes a light-emitting component (for example, an organic light-emitting diode (OLED) 101, though the invention is not limited thereto, and the pixel circuit 10 can be regarded as an OLED pixel circuit) and a light-emitting component driving circuit 103. The light-emitting component driving circuit 103 includes a power unit 105, a driving unit 107 and a data storage unit 109.

In the present exemplary embodiment, the power unit 105 receives a power supply voltage Vdd, and conducts the power supply voltage Vdd in response to a light enable signal LE in a light enable phase.

In addition, the driving unit 107 is coupled between the power unit 105 and an anode of the OLED 101 (i.e. a first end of the light-emitting component), and includes a driving transistor T1 directly coupled to the anode of the OLED 101, wherein a cathode of the OLED 101 (i.e. a second end of the light-emitting component) receives the light enable signal LE. The driving unit 107 controls a driving current I_{OLED} flowing through the OLED 101 in the light enable phase.

Furthermore, the data storage unit 109 includes a storage capacitor Cst. The data storage unit 109 is adapted (or configured) to store a data voltage (Vdata) and a threshold voltage (Vₜₕ(T1)) related to the driving transistor T1 through the storage capacitor Cst in a data-writing phase. Moreover, in a reset phase, the data storage unit 109 initializes/resets the storage capacitor Cst in response to a reset scan signal S[n−1]. The reset scan signal S[n−1] may be a signal on a previous scan line, and is provided by a gate driving circuit of an (n−1)^{th} stage.

In the present exemplary embodiment, in the light enable phase, the driving unit 107 generates the driving current I_{OLED} flowing through the OLED 101 in response to a cross-voltage of the storage capacitor Cst, where the driving current I_{OLED} is not influenced by the threshold voltage (Vₜₕ(T1)) of the driving transistor T1. In other words, the driving current I_{OLED} is non-related to the threshold voltage (Vₜₕ(T1)) of the driving transistor T1.

Besides, the power unit 105 includes a power conduction transistor T2. Moreover, the data storage unit 107 further includes a writing transistor T3, a collection transistor T4 and a reset transistor T5.

In the present exemplary embodiment, the driving transistor T1, the power conduction transistor T2, the writing transistor T3, the collection transistor T4 and the reset transistor are all P-type transistors, for example, P-type thin-film-transistors (P-type TFTs). Moreover, an OLED display panel applying the (OLED) pixel circuit 10 can be fabricated according to a low temperature polysilicon (LTPS), an a-Si or an a-IGZO TFT process technique, though the invention is not limited thereto.

In a circuit configuration of the (OLED) pixel circuit 10 of FIG. 2, a source of the power conduction transistor T2 receives the power supply voltage Vdd, and a gate of the power conduction transistor T2 receives the light enable signal LE. A first drain/source (which is also referred to as a first electrode) of the driving transistor T1 is coupled to a drain of the power conduction transistor T2, a second drain/source (which is also referred to as a second electrode) of the driving transistor T1 is coupled to the anode of the OLED 101, and a gate of the driving transistor T1 is coupled to a first end of the storage capacitor Cst. Moreover, a second end of the storage capacitor Cst may be coupled to the power supply voltage Vdd.

A gate of the writing transistor T3 receives a writing scan signal S[n] (the writing scan signal S[n] may be a signal on a current scan line, and is provided by a gate driving circuit of an n^{th} stage), a drain of the writing transistor T3 receives a data voltage V_{IN}, and a source of the writing transistor T3 is coupled to the second drain/source of the driving transistor T1 and the anode of the OLED 101. A gate of the collection transistor T4 receives the writing scan signal S[n], a source of the collection transistor T4 is coupled to the gate of the driving transistor T1 and the first end of the storage capacitor Cst, and a drain of the collection transistor T4 is coupled to the first drain/source of the driving transistor T1 and the drain of the power conduction transistor T2. A gate of the reset transistor T5 is coupled to a source thereof to receive the reset scan signal S[n−1], and a drain of the reset transistor T5 is coupled to the gate of the driving transistor T1, the source of the collection transistor T4 and the first end of the storage capacitor Cst.

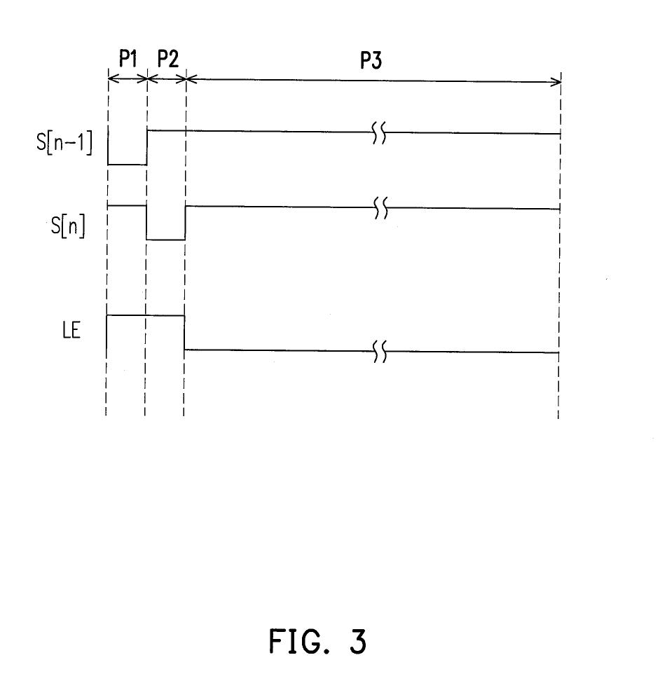

During an operation process of the (OLED) pixel circuit 10 of FIG. 2, the light-emitting component driving circuit 103 (i.e. the OLED driving circuit) sequentially enters the reset phase, the data-writing phase and the light enable phase, which are respectively P1, P2 and P3 shown in FIG. 3. In the present exemplary embodiment, in the reset phase P1, only the reset scan signal S[n−1] is enabled; in the data-writing phase P2, only the writing scan signal S[n] is enabled; and in the light enable phase P3, only the light enable signal LE is enabled. In other words, in the reset phase P1, the reset scan signal S[n−1] is enabled, and the writing scan signal S[n] and the light enable signal LE are disabled. In the data-writing phase P2, the writing scan signal S[n] is enabled, and the reset scan signal S[n−1] and the light enable signal LE are disabled. In the light enable phase P3, the light enable signal LE is enabled, and the reset scan signal S[n−1] and the writing scan signal S[n] are disabled. Certainly, high and low levels of the reset scan signal S[n−1], the writing scan signal S[n] and the light enable signal LE can be determined according to an actual design/application requirement.

It should be noticed that since the driving transistor T1, the power conduction transistor T2, the writing transistor T3, the collection transistor T4 and the reset transistor T5 in the (OLED) pixel circuit 10 of FIG. 2 are all P-type transistors, the driving transistor T1, the power conduction transistor T2, the writing transistor T3, the collection transistor T4 and the reset transistor T5 are all low active. Therefore, enabling of the reset scan signal S[n−1], the writing scan signal S[n] and the light enable signal LE presents that the reset scan signal S[n−1], the writing scan signal S[n] and the light enable signal LE are in a low level.

Therefore, in the reset phase P1, since only the reset scan signal S[n−1] is enabled, a voltage of the gate of the driving transistor T1 is equal to Vₜₕ(T5) in response to a turn-on state of the reset transistor T5, where Vₜₕ(T5) is a threshold voltage of the reset transistor T5. Meanwhile, in response to disabling of the light enable signal LE, the power conduction transistor T2 is in a turn-off state, so as to avoid a miss operation of sudden light up of the OLED 101, and maintain a contrast of a displayed image. Moreover, in response to disabling of the writing scan signal S[n], the writing transistor T3 and the collection transistor T4 are also in the turn-off state.

Then, in the data-writing phase P2, since only the writing scan signal S[n] is enabled, the writing transistor T3 and the collection transistor T4 are simultaneously in the turn-on state. In this case, the data voltage V_{IN} (it is assumed that the data voltage V_{IN} is the data voltage Vdata, i.e. V_{IN}=Vdata, though the invention is not limited thereto) is transmitted to the storage capacitor Cst through the writing transistor T3 and the diode-connected driving transistor T1, so that the voltage of the gate of the driving transistor T1 is equal to Vdata−Vₜₕ(T1). In the data-writing phase P2, the second drain/source (the second electrode) of the driving transistor T1 is substantially regarded as the source, and the first drain/source (the first electrode) of the driving transistor T1 is substantially regarded as the drain.

Meanwhile, in response to disabling of the reset scan signal S[n−1] and the light enable signal LE, the reset transistor T5 and the power conduction transistor T2 are simultaneously in the turn-off state, and miss operation of sudden light up of the OLED 101 in the data-writing phase P2 is avoided since the level of the light enable signal LE in the disable state is greater than the data voltage V_{IN} (Vdata).

Finally, in the light enable phase P3, since only the light enable signal LE is enabled, the writing transistor T3, the collection transistor T4 and the reset transistor T5 are all in the turn-off state, and the driving transistor T1 and the power conduction transistor T2 are in the turn-on state. Meanwhile, since the second drain/source of the driving transistor T1 is changed to the drain, and the first drain/source of the driving transistor T1 is changed to the source, in response to the turn-on state of the power conduction transistor T2, a voltage of the source of the driving transistor T1 is substantially equal to the power supply voltage Vdd, and the voltage of the gate of the driving transistor T1 is maintained to Vdata−Vₜₕ(T1). In this way, the driving transistor T1 generates the driving current I_{OLED} that is not influenced by the threshold voltage (Vₜₕ(T1)) of the driving transistor T1 to flow through the OLED 101.

In detail, under the circuit configuration of FIG. 2, the driving current I_{OLED} generated by the driving transistor T1 in the light enable phase P3 can be represented by a following equation 1:

$${I}_{OLED} = \frac{1}{2} K \times {( Vsg - {V}_{th} ( T 1 ) )}^{2} , \qquad 1$$

where, K is a current constant related to the driving transistor T1.

Moreover, since a source gate voltage (Vsg) of the driving transistor T1 is known, i.e. Vsg=Vdd−[Vdata−Vₜₕ(T1)], if the known source gate voltage (Vsg) of the driving transistor T1 is brought into the equation 1, a following equation 2 is obtained:

$${I}_{OLED} = \frac{1}{2} K \times {[ Vdd - ( Vdata - {V}_{th} ( T 1 ) ) - {V}_{th} ( T 1 ) ]}^{2} , \qquad 2$$

the equation 2 can be further simplified into a following equation 3:

$${I}_{OLED} = \frac{1}{2} K \times {( Vdd - Vdata )}^{2} \qquad 3$$

Therefore, the driving transistor T1 can generate the driving current I_{OLED} that is not influenced by the threshold voltage (Vₜₕ(T1)) of the driving transistor T1 in the light enable phase P3.

In other words, according to the equation 3, it is obvious that the driving current I_{OLED} flowing through the OLED 101 is non-related to the threshold voltage (Vₜₕ(T1)) of the driving transistor T1. In this way, threshold voltage variation of the TFT caused by process factors can be compensated.

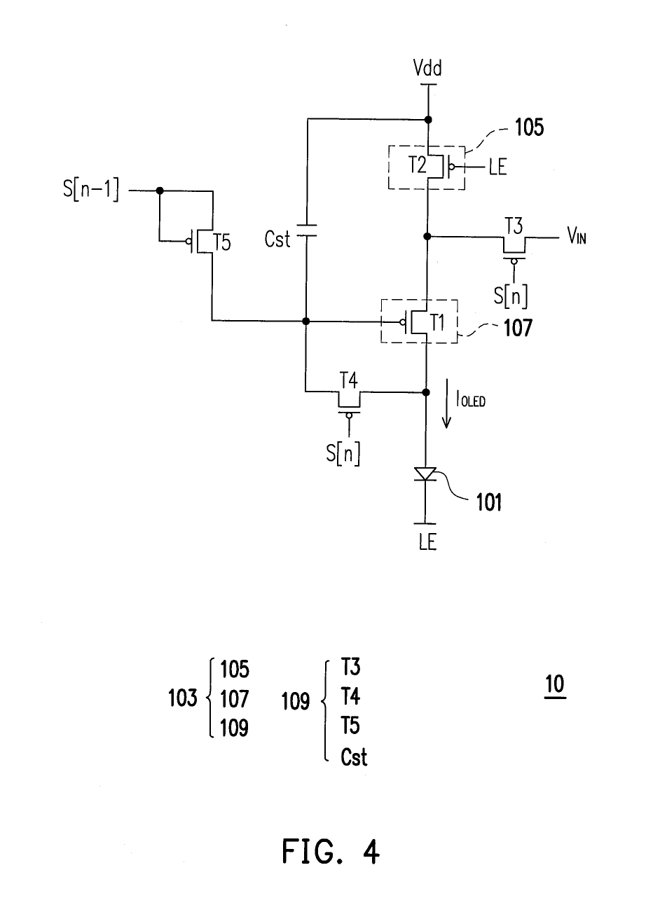

On the other hand, FIG. 4 is an implementation circuit diagram of the (OLED) pixel circuit 10 of FIG. 1 according to another embodiment of the invention. Referring to FIG. 1 and FIG. 4, in the present exemplary embodiment, in the circuit configuration of the (OLED) pixel circuit 10 of FIG. 4, the source of the power conduction transistor T2 receives the power supply voltage Vdd, and the gate of the power conduction transistor T2 receives the light enable signal LE. The first drain/source (the first electrode) of the driving transistor T1 is coupled to the drain of the power conduction transistor T2, the second drain/source (the second electrode) of the driving transistor T1 is coupled to the anode of the OLED 101, and the gate of the driving transistor T1 is coupled to the first end of the storage capacitor Cst. Moreover, the second end of the storage capacitor Cst is coupled to the power supply voltage Vdd.

The gate of the writing transistor T3 receives the writing scan signal S[n], the drain of the writing transistor T3 receives the data voltage V_{IN}, and the source of the writing transistor T3 is coupled to the first drain/source of the driving transistor T1 and the drain of the power conduction transistor T2. The gate of the collection transistor T4 receives the writing scan signal S[n], the source of the collection transistor T4 is coupled to the gate of the driving transistor T1, and the drain of the collection transistor T4 is coupled to the second drain/source of the driving transistor T1 and the anode of the OLED 101. The gate of the reset transistor T5 is coupled to the source thereof to receive the reset scan signal S[n−1], and the drain of the reset transistor T5 is coupled to the gate of the driving transistor T1, the source of the collection transistor T4 and the first end of the storage capacitor Cst.

It should be noticed that the operation waveforms of FIG. 3 are also suitable for the circuit configuration of FIG. 4, and an operation method of the circuit configuration of FIG. 4 collocating with the operation waveforms of FIG. 3 is the same to that of FIG. 2, and details thereof are not repeated. In other words, in FIG. 4, the driving transistor T1 can also generate the driving current I_{OLED} that is not influenced by the threshold voltage (Vₜₕ(T1)) of the driving transistor T1 in the light enable phase P3 (shown as the aforementioned equations 1-3) for flowing through the OLED 101. Obviously, the circuit configuration of FIG. 4 can also achieve technical effects similar to that of the exemplary embodiment of FIG. 2.

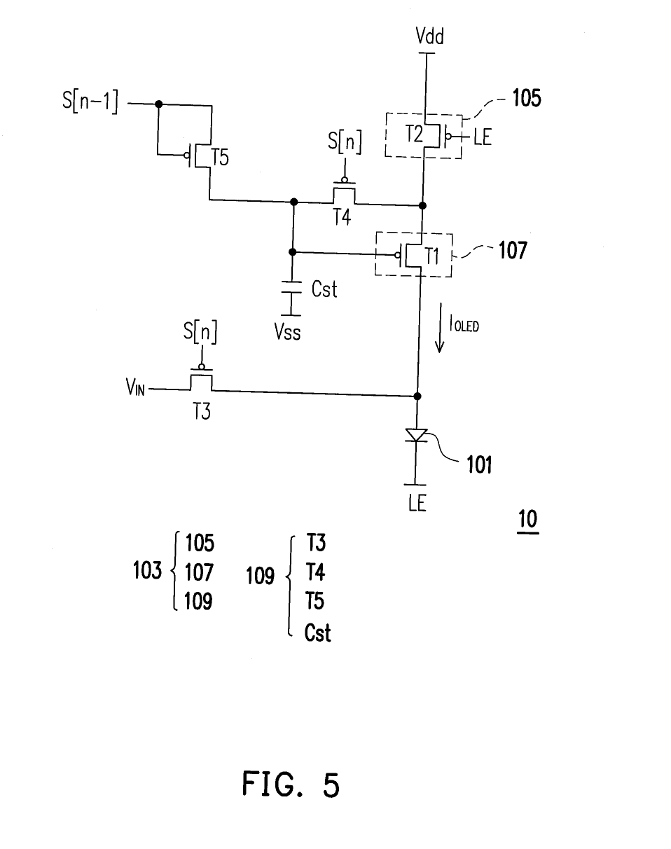

On the other hand, FIG. 5 is an implementation circuit diagram of the (OLED) pixel circuit 10 of FIG. 1 according to still another embodiment of the invention. Referring to FIG. 1, FIG. 2 and FIG. 5, in the present exemplary embodiment, a difference between the circuit configurations of the (OLED) pixel circuit 10 of FIG. 5 and FIG. 2 is that the second end of the storage capacitor Cst of the (OLED) pixel circuit 10 of FIG. 5 is changed to be coupled to a reference voltage Vss other than to couple to the power supply voltage Vdd as that does in the aforementioned exemplary embodiment. In this case, in the light enable phase P3, the driving current I_{OLED} flowing through the OLED 101 that is generated by the driving unit 107 in response to the cross-voltage of the storage capacitor Cst is also not influenced by the threshold voltage (Vₜₕ(T1)) of the driving transistor T1. Herein, since the operation waveforms of FIG. 3 are also suitable for the circuit configuration of FIG. 5, and an operation method of the circuit configuration of FIG. 5 collocating with the operation waveforms of FIG. 3 is the same to that of the aforementioned exemplary embodiment, and details thereof are not repeated.

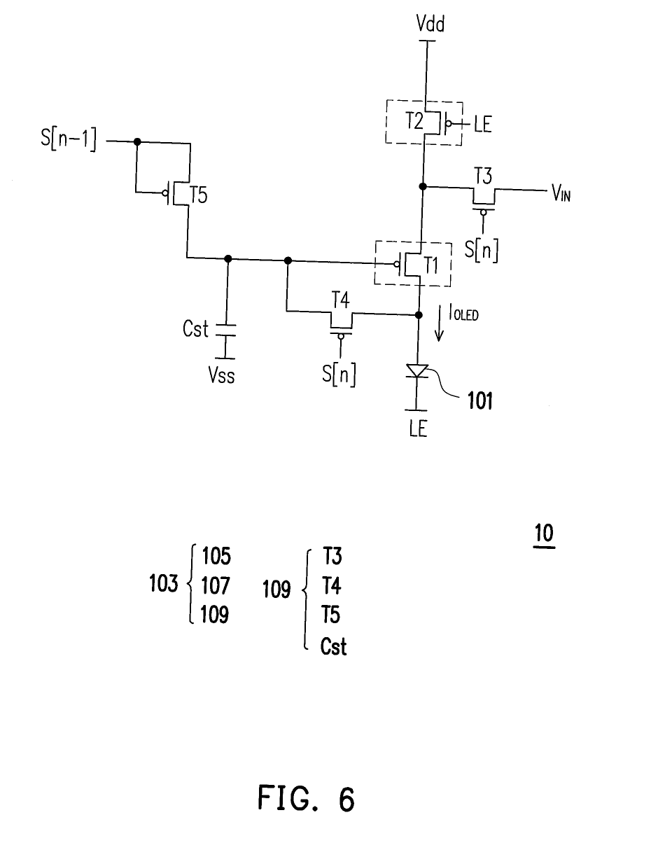

Similarly, FIG. 6 is an implementation circuit diagram of the (OLED) pixel circuit 10 of FIG. 1 according to yet another embodiment of the invention. Referring to FIG. 1 and FIG. 6, in the present exemplary embodiment, in the circuit configuration of the (OLED) pixel circuit 10 of FIG. 6, the source of the power conduction transistor T2 receives the power supply voltage Vdd, and the gate of the power conduction transistor T2 receives the light enable signal LE. The first drain/source (the first electrode) of the driving transistor T1 is coupled to the drain of the power conduction transistor T2, the second drain/source (the second electrode) of the driving transistor T1 is coupled to the anode of the OLED 101, and the gate of the driving transistor T1 is coupled to the first end of the storage capacitor Cst. Moreover, the second end of the storage capacitor Cst is coupled to the reference voltage Vss.

The gate of the writing transistor T3 receives the writing scan signal S[n], the drain of the writing transistor T3 receives the data voltage V_{IN}, and the source of the writing transistor T3 is coupled to the first drain/source of the driving transistor T1 and the drain of the power conduction transistor T2. The gate of the collection transistor T4 receives the writing scan signal S[n], the source of the collection transistor T4 is coupled to the gate of the driving transistor T1 and the first end of the storage capacitor Cst, and the drain of the collection transistor T4 is coupled to the second drain/source of the driving transistor T1 and the anode of the OLED 101. The gate of the reset transistor T5 is coupled to the source thereof to receive the reset scan signal S[n−1], and the drain of the reset transistor T5 is coupled to the gate of the driving transistor T1, the source of the collection transistor T4 and the first end of the storage capacitor Cst.

It should be noticed that the operation waveforms of FIG. 3 are also suitable for the circuit configuration of FIG. 6, and an operation method of the circuit configuration of FIG. 6 collocating with the operation waveforms of FIG. 3 is the same to that of FIG. 5, and details thereof are not repeated. In other words, in FIG. 6, the driving transistor T1 can also generate the driving current I_{OLED} that is not influenced by the threshold voltage (Vₜₕ(T1)) of the driving transistor T1 in the light enable phase P3 for flowing through the OLED 101.

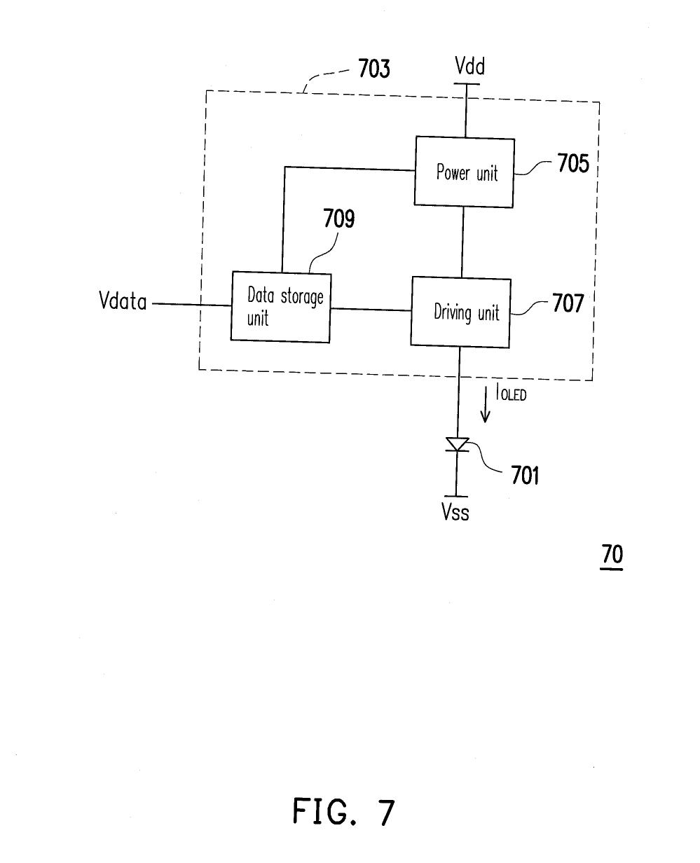

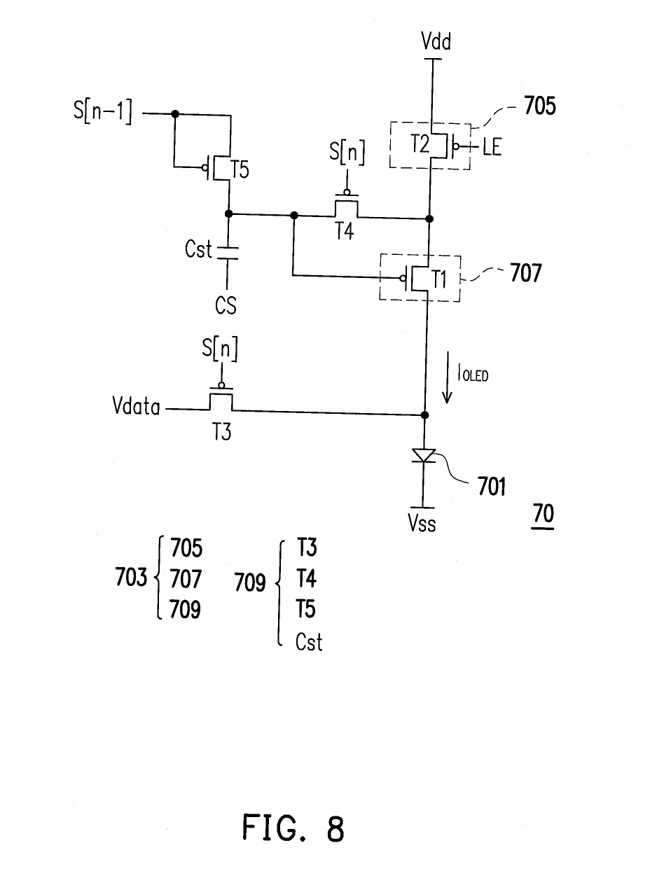

Besides, FIG. 7 is a schematic diagram of a pixel circuit 70 according to an exemplary embodiment of the invention, and FIG. 8 is an implementation circuit diagram of the pixel circuit 70 of FIG. 7. Referring to FIGS. 7 and 8, the pixel circuit 70 of the present exemplary embodiment includes a light-emitting component (for example, an organic light-emitting diode (OLED) 701, though the invention is not limited thereto) and a light-emitting component driving circuit 703. The light-emitting component driving circuit 703 similarly includes a power unit 705, a driving unit 707 and a data storage unit 709.

In the present exemplary embodiment, the power unit 705 receives a power supply voltage Vdd, and conducts the power supply voltage Vdd in response to a light enable signal LE in a light enable phase. Herein, the power supply voltage Vdd can be a power supply voltage with fixed level, so the power supply voltage Vdd is referred to as the fixed power supply voltage Vdd hereafter.

In addition, the driving unit 707 is coupled between the power unit 705 and an anode of the OLED 701 (i.e. a first end of the light-emitting component), and includes a driving transistor T1 directly coupled to the anode of the OLED 701. The driving unit 707 controls a driving current I_{OLED} flowing through the OLED 701 in the light enable phase.

Furthermore, the data storage unit 709 includes a storage capacitor Cst. The data storage unit 109 is adapted (or configured) to store a data voltage (Vdata) and a threshold voltage (Vₜₕ(T1)) related to the driving transistor T1 through the storage capacitor Cst in a data-writing phase. Moreover, in a reset phase, the data storage unit 709 initializes/resets the storage capacitor Cst in response to a reset scan signal S[n−1]. The reset scan signal S[n−1] may be a signal on a previous scan line, and is provided by a gate driving circuit of an (n−1)^{th} stage.

In the present exemplary embodiment, in the light enable phase, the driving unit 707 generates the driving current I_{OLED} flowing through the OLED 701 in response to a cross-voltage of the storage capacitor Cst, where the driving current I_{OLED} is substantially not influenced by the threshold voltage (Vₜₕ(T1)) of the driving transistor T1, and an impact of the power supply voltage Vdd on the driving current I_{OLED} can also be effectively reduced/mitigated/released. In other words, the driving current I_{OLED} is non-related to the threshold voltage (Vₜₕ(T1)) of the driving transistor T1, and is less or even not related to the power supply voltage Vdd (the details would be described later).

Besides, the power unit 705 includes a power conduction transistor T2. Moreover, the data storage unit 707 further includes a writing transistor T3, a collection transistor T4 and a reset transistor T5.

In the present exemplary embodiment, the driving transistor T1, the power conduction transistor T2, the writing transistor T3, the collection transistor T4 and the reset transistor are all P-type transistors, for example, P-type thin-film-transistors (P-type TFTs). Moreover, an OLED display panel applying the (OLED) pixel circuit 10 can be fabricated according to a low temperature polysilicon (LTPS), an a-Si or an a-IGZO TFT process technique, though the invention is not limited thereto.

In a circuit configuration of the (OLED) pixel circuit 70 of FIG. 7, a source of the power conduction transistor T2 receives the fixed power supply voltage Vdd, and a gate of the power conduction transistor T2 receives the light enable signal LE. A first drain/source (which is also referred to as a first electrode) of the driving transistor T1 is coupled to a drain of the power conduction transistor T2, a second drain/source (which is also referred to as a second electrode) of the driving transistor T1 is coupled to the anode of the OLED 101, and a gate of the driving transistor T1 is coupled to a first end of the storage capacitor Cst. Moreover, a second end of the storage capacitor Cst may be coupled to a control signal CS which is not related to power.

A gate of the writing transistor T3 receives a writing scan signal S[n] (the writing scan signal S[n] may be a signal on a current scan line, and is provided by a gate driving circuit of an n^{th} stage), a drain of the writing transistor T3 receives a data voltage Vdata, and a source of the writing transistor T3 is coupled to the second drain/source (the second electrode) of the driving transistor T1 and the anode of the OLED 701. A gate of the collection transistor T4 receives the writing scan signal S[n], a source of the collection transistor T4 is coupled to the gate of the driving transistor T1 and the first end of the storage capacitor Cst, and a drain of the collection transistor T4 is coupled to the first drain/source (the first electrode) of the driving transistor T1 and the drain of the power conduction transistor T2. A gate of the reset transistor T5 is coupled to a source thereof to receive the reset scan signal S[n−1], and a drain of the reset transistor T5 is coupled to the gate of the driving transistor T1, the source of the collection transistor T4 and the first end of the storage capacitor Cst.

In this case, the cathode of the OLED 701 (i.e. a second terminal of the light-emitting component) may be coupled to a fixed reference voltage Vss, where the level of the fixed reference voltage Vss is substantially not less than the highest level of the data voltage Vdata minus the conduction voltage (Voled_th) of the OLED 701, namely, Vss≧Vdata−Voled_th.

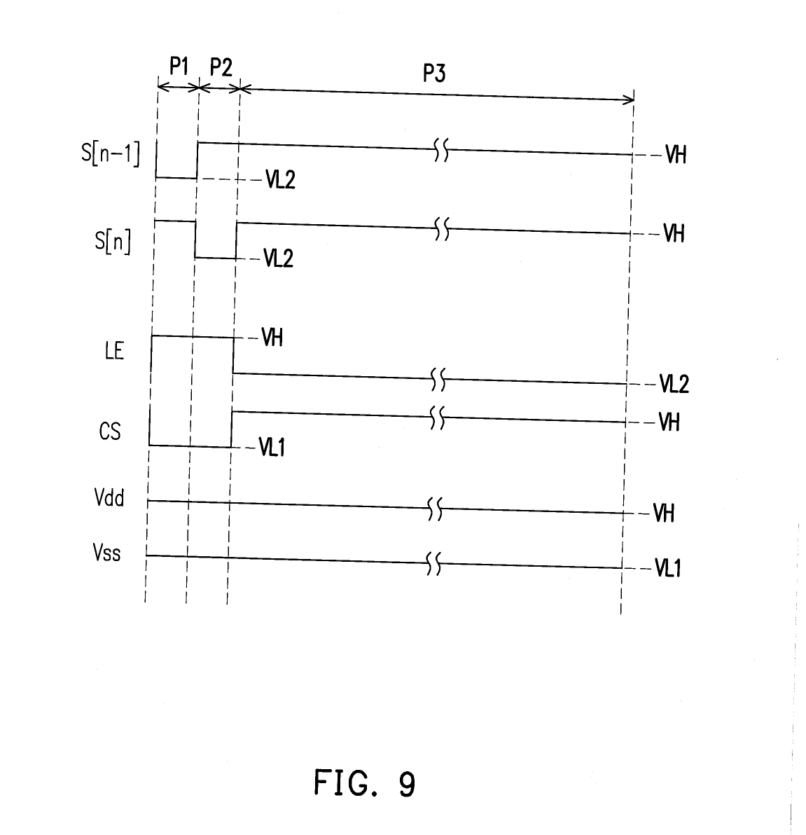

During an operation process of the (OLED) pixel circuit 70 of FIG. 7, the light-emitting component driving circuit 703 (i.e. the OLED driving circuit) sequentially enters the reset phase, the data-writing phase and the light enable phase, which are respectively P1, P2 and P3 shown in FIG. 9. In the present exemplary embodiment, the control signal CS has a first low voltage level VL1 (for example, +4V, but not limited thereto) in the reset phase P1 and the data-writing phase P2, and the control signal CS has a high voltage level VH (for example, +14V, but not limited thereto) in the light enable phase P3.

The light enable signal LE has the high voltage level VH in the reset phase P1 and the data-writing phase P2, and the light enable signal LE has a second low voltage level VL2 (for example, −6V, but not limited thereto) which is different from the first low voltage level VL1 in the light enable phase P3. The reset scan signal S[n−1] has the second low voltage level VL2 in the reset phase P1, and the reset scan signal S[n−1] has the high voltage level VH in the data-writing phase P2 and the light enable phase P3. The writing scan signal S[n] has the second low voltage level VL2 in the data-writing phase P2, and the writing scan signal S[n] has the high voltage level VH in the reset phase P1 and the light enable phase P3.

In other words, in the reset phase P1, only the reset scan signal S[n−1] is enabled. In the data-writing phase P2, only the writing scan signal S[n] is enabled. In the light enable phase P3, only the light enable signal LE is enabled. The control signal CS is only activated (i.e. at the high voltage level VH) in the light enable phase P3. It should be noticed that since the driving transistor T1, the power conduction transistor T2, the writing transistor T3, the collection transistor T4 and the reset transistor T5 in the (OLED) pixel circuit 70 of FIG. 8 are all P-type transistors, the driving transistor T1, the power conduction transistor T2, the writing transistor T3, the collection transistor T4 and the reset transistor T5 are all low active. Therefore, enabling of the reset scan signal S[n−1], the writing scan signal S[n] and the light enable signal LE presents that the reset scan signal S[n−1], the writing scan signal S[n] and the light enable signal LE are in a low level (i.e. VL2).

Therefore, in the reset phase P1, since only the reset scan signal S[n−1] is enabled, a voltage of the gate of the driving transistor T1 is equal to VL2+Vₜₕ(T5) in response to a turn-on state of the reset transistor T5, where Vₜₕ(T5) is a threshold voltage of the reset transistor T5. Meanwhile, in response to disabling of the light enable signal LE, the power conduction transistor T2 is in a turn-off state, so as to avoid a miss operation of sudden light up of the OLED 701, and maintain a contrast of a displayed image. Moreover, in response to disabling of the writing scan signal S[n], the writing transistor T3 and the collection transistor T4 are also in the turn-off state.

Then, in the data-writing phase P2, since only the writing scan signal S[n] is enabled, the writing transistor T3 and the collection transistor T4 are simultaneously in the turn-on state. In this case, the data voltage Vdata is transmitted to the storage capacitor Cst through the writing transistor T3 and the diode-connected driving transistor T1, so that the voltage of the gate of the driving transistor T1 is equal to Vdata−Vₜₕ(T1). In the data-writing phase P2, the second drain/source (the second electrode) of the driving transistor T1 is substantially regarded as the source, and the first drain/source (the first electrode) of the driving transistor T1 is substantially regarded as the drain.

Meanwhile, in response to disabling of the reset scan signal S[n−1] and the light enable signal LE, the reset transistor T5 and the power conduction transistor T2 are simultaneously in the turn-off state, and further, the level of the fixed reference voltage Vss is substantially not less than the highest level of the data voltage Vdata minus the conduction voltage (Voled_th) of the OLED 701, namely, Vss≧Vdata−Voled_th, so miss operation of sudden light up of the OLED 701 in the data-writing phase P2 is also avoided.

Finally, in the light enable phase P3, since only the light enable signal LE is enabled, the writing transistor T3, the collection transistor T4 and the reset transistor T5 are all in the turn-off state, and the driving transistor T1 and the power conduction transistor T2 are in the turn-on state. Meanwhile, since the second drain/source (the second electrode) of the driving transistor T1 is changed to the drain, and the first drain/source (the first electrode) of the driving transistor T1 is changed to the source, in response to the turn-on state of the power conduction transistor T2, the voltage of the source of the driving transistor T1 is substantially equal to VH, and the voltage of the gate of the driving transistor T1 would be affected by the activated control signal CS (which is at the high voltage level VH), and rise to Vdata−Vₜₕ(T1)+VH−VL1 in response to a capacitor coupling effect of the storage capacitor Cst. In this way, the driving current I_{OLED} is completely unaffected by the threshold voltage Vₜₕ(T1) of the driving transistor T1, and the impact of the power supply voltage Vdd (which changes in response to IR drop) on the driving current I_{OLED} is also effectively mitigated.

To be specific, the driving current I_{OLED} generated by the driving transistor T1 in the light enable phase P3 can be expressed with following expression 4:

$${I}_{OLED} = \frac{1}{2} K \times {( Vsg - {V}_{th} ( T 1 ) )}^{2} \qquad 4$$

where, K is a current constant related to the driving transistor T1.

Moreover, since a source gate voltage (Vsg) of the driving transistor T1 is known, i.e. Vsg=Vs−Vg=VH−[Vdata−Vₜₕ(T1)+VH−VL1].

Obviously, the source voltage (Vs) of the driving transistor T1 in the pixel circuit 70 is equal to VH, where “VH” is the highest level of the fixed power supply voltage Vdd (for example, denoted as VH_{Vdd}). Moreover, the gate voltage (Vg) of the driving transistor T1 in the pixel circuit 70 is equal to Vdata−Vₜₕ(T1)+VH−VL1, where “VH” is the high voltage level of the control signal CS (for example, denoted as VH_{CS}).

In practice, since the fixed power supply voltage Vdd and the control signal CS are different in circuit layout, VH_{Vdd}−VH_{CS} is substantially not equal to zero. Accordingly, the driving current I_{OLED} generated by the driving transistor T1 in FIG. 8 may be affected by any change of the power supply voltage Vdd caused by IR (current/resistance) drop. However, if the impact of IR drop on the highest level VH_{Vdd} of the fixed power supply voltage Vdd is made substantially equal to the impact of RC (resistance/capacitance) loading effect on the high voltage level VH_{CS} of the control signal CS through an appropriate layout design (i.e. VH_{Vdd}−VH_{CS} is substantially and almost equal to zero, but not limited thereto), the impact of the power supply voltage Vdd (which changes in response to IR drop) on the driving current I_{OLED} generated by the driving transistor T1 in FIG. 8 can be effectively mitigated.

On the other hand, the low voltage level VL1 of the control signal CS and the low voltage level of the fixed reference voltage Vss are preferably the same, but not limited thereto.

In following description, it is assumed that VH_{Vdd}≈VH_{CS}, such that following expression 5 is obtained by bringing the source-gate voltage (Vsg) of the driving transistor T1 into foregoing expression 4:

$${I}_{OLED} = \frac{1}{2} K \times {[ {VH}_{Vdd} - ( Vdata - {V}_{th} ( T 1 ) + {VH}_{cs} - VL 1 ) - {V}_{th} ( T 1 ) ]}^{2} , \qquad 5$$

the equation 5 can be further simplified into a following equation 6:

$${I}_{OLED} = \frac{1}{2} K \times {[ ( {VH}_{Vdd} - {VH}_{CS} ) - Vdata + VL 1 ]}^{2} . \qquad 6$$

However, if the highest level VH_{Vdd} of the power supply voltage Vdd and the high voltage level VH_{CS} of the control signal CS are designed to be substantially equal to each other (i.e., VH_{Vdd}=VH_{CS}), foregoing expression 6 can be further simplified into following expression 7:

$${I}_{OLED} = \frac{1}{2} K \times {( VL 1 - Vdata )}^{2} . \qquad 7$$

It is known that the driving transistor T1 can generate the driving current I_{OLED} which is substantially unaffected by the threshold voltage Vₜₕ(T1) of the driving transistor T1 in the light enable phase P3, and the impact of the power supply voltage Vdd (which changes in response to IR drop) on the generated driving current I_{OLED} is effectively mitigated (if VH_{Vdd} is not equal to VH_{CS}). Even, the generated driving current I_{OLED} may be completely unaffected by the power supply voltage Vdd that changes in response to IR drop (if VH_{Vdd} is equal to VH_{CS}).

In other words, as clearly indicated by foregoing expression 7, the driving current I_{OLED} flowing through the OLED 701 is substantially unrelated to the (fixed) power supply voltage Vdd and the threshold voltage Vₜₕ(T1) of the driving transistor T1 and is only related to the data voltage Vdata. Thereby, any variation on the threshold voltage of a TFT caused by process factors can be compensated, and any change of the power supply voltage Vdd caused by IR drop can be compensated at the same time.

It should be noted that the control single CS is a signal that is not related or belong to power. Accordingly, the (OLED) pixel circuit 70 can be operated under a relatively stable power supply (Vdd, Vss). And, the whole layout area and the design complexity of the control circuit (not shown) used for controlling the operation of the pixel circuit 70 can further be effectively reduced due to any problem related to power does not be considered.

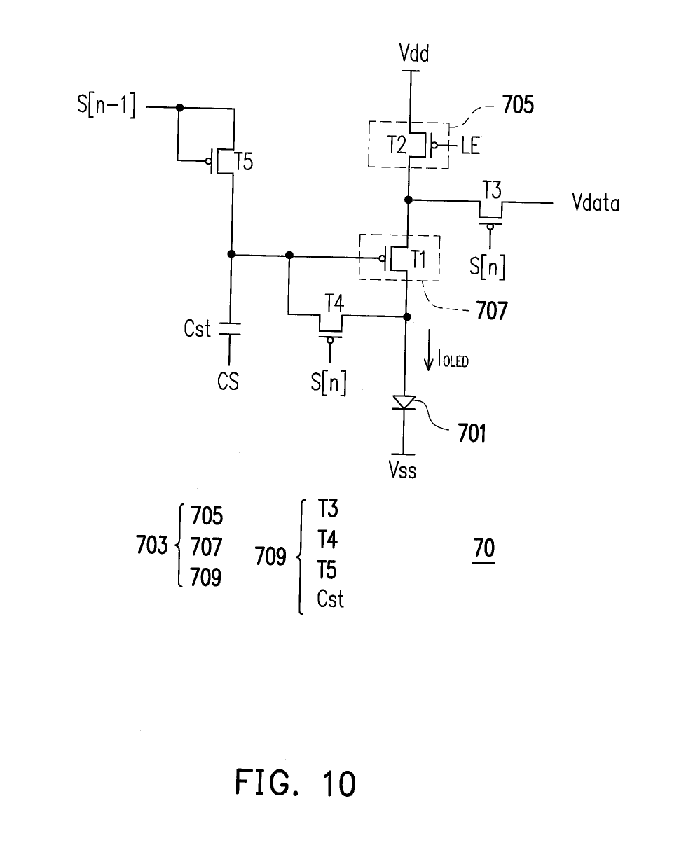

FIG. 10 is a circuit diagram of the pixel circuit 70 of FIG. 7 according to another embodiment of the invention. Referring to FIGS. 7 and 10, in the present exemplary embodiment, in a circuit configuration of the (OLED) pixel circuit 70 of FIG. 10, the source of the power conduction transistor T2 similarly receives the fixed power supply voltage Vdd, and the gate of the power conduction transistor T2 similarly receives the light enable signal LE. The first drain/source (the first electrode) of the driving transistor T1 is similarly coupled to the drain of the power conduction transistor T2, the second drain/source (the second electrode) of the driving transistor T1 is similarly coupled to the anode of the OLED 701 (i.e. the light-emitting component), and the gate of the driving transistor T1 is similarly coupled to the first end of the storage capacitor Cst. Moreover, the second end of the storage capacitor Cst may similarly be coupled to the control signal CS.

The gate of the writing transistor T3 similarly receives the writing scan signal S[n], the drain of the writing transistor T3 similarly receives the data voltage Vdata, and the source of the writing transistor T3 is changed to be coupled to the first drain/source (the first electrode) of the driving transistor T1 and the drain of the power conduction transistor T2. The gate of the collection transistor T4 similarly receives the writing scan signal S[n], the source of the collection transistor T4 is similarly coupled to the gate of the driving transistor T1 and the first end of the storage capacitor Cst, and the drain of the collection transistor T4 is similarly changed to be coupled to the second drain/source (the second electrode) of the driving transistor T1 and the anode of the OLED 701. The gate of the reset transistor T5 is similarly coupled to the source thereof to receive the reset scan signal S[n−1], and the drain of the reset transistor T5 is similarly coupled to the gate of the driving transistor T1, the source of the collection transistor T4 and the first end of the storage capacitor Cst.

In this case, the cathode of the OLED 701 may similarly be coupled to the fixed reference voltage Vss, where the level of the fixed reference voltage Vss is substantially not less than the highest level of the data voltage Vdata minus the threshold voltage (Vₜₕ(T1)) of the driving transistor T1 and the conduction voltage (Voled_th) of the OLED 701, namely, Vss≧Vdata−Vₜₕ(T1)−Voled_th.

It should be noted that the operation waveforms of FIG. 9 are also suitable for the circuit configuration of FIG. 10. Therefore, in the reset phase P1, since only the reset scan signal S[n−1] is enabled, a voltage of the gate of the driving transistor T1 is equal to VL2+Vₜₕ(T5) in response to a turn-on state of the reset transistor T5, where Vₜₕ(T5) is a threshold voltage of the reset transistor T5. Meanwhile, in response to disabling of the light enable signal LE, the power conduction transistor T2 is in a turn-off state, so as to avoid a miss operation of sudden light up of the OLED 701, and maintain a contrast of a displayed image. Moreover, in response to disabling of the writing scan signal S[n], the writing transistor T3 and the collection transistor T4 are also in the turn-off state.

Then, in the data-writing phase P2, since only the writing scan signal S[n] is enabled, the writing transistor T3 and the collection transistor T4 are simultaneously in the turn-on state. In this case, the data voltage Vdata is transmitted to the storage capacitor Cst through the writing transistor T3 and the diode-connected driving transistor T1, so that the voltage of the gate of the driving transistor T1 is equal to Vdata−Vₜₕ(T1). In the data-writing phase P2, the second drain/source (the second electrode) of the driving transistor T1 is substantially regarded as the source, and the first drain/source (the first electrode) of the driving transistor T1 is substantially regarded as the drain.

Meanwhile, in response to disabling of the reset scan signal S[n−1] and the light enable signal LE, the reset transistor T5 and the power conduction transistor T2 are simultaneously in the turn-off state, and further, the level of the fixed reference voltage Vss is substantially not less than the highest level of the data voltage Vdata minus the threshold voltage (Vₜₕ(T1)) of the driving transistor T1 and the conduction voltage (Voled_th) of the OLED 701, namely, Vss≧Vdata−Vₜₕ(T1)−Voled_th, so miss operation of sudden light up of the OLED 701 in the data-writing phase P2 is also avoided.

Finally, in the light enable phase P3, since only the light enable signal LE is enabled, the writing transistor T3, the collection transistor T4 and the reset transistor T5 are all in the turn-off state, and the driving transistor T1 and the power conduction transistor T2 are in the turn-on state. Meanwhile, since the second drain/source (the second electrode) of the driving transistor T1 is changed to the drain, and the first drain/source (the first electrode) of the driving transistor T1 is changed to the source, in response to the turn-on state of the power conduction transistor T2, the voltage of the source of the driving transistor T1 is substantially equal to VH, and the voltage of the gate of the driving transistor T1 would be affected by the activated control signal CS (which is at the high voltage level VH), and rise to Vdata−Vₜₕ(T1)+VH−VL1 in response to a capacitor coupling effect of the storage capacitor Cst. In this way, the driving transistor T1 can generate the driving current I_{OLED} which is substantially unaffected by the threshold voltage Vₜₕ(T1) of the driving transistor T1 and the power supply voltage Vdd (as the foregoing expressions 4-7 in case that VH_{Vdd} is equal to VH_{CS}) for flowing through the OLED 701. Obviously, the circuit configuration illustrated in FIG. 10 can achieve similar technical effects as that of the circuit configuration in the exemplary embodiment illustrated in FIG. 8.

Therefore, the circuit configuration of the (OLED) pixel circuit 10/70 disclosed by the aforementioned exemplary embodiments is 5T1C (i.e. 5 TFTs+1 capacitor), and if the circuit configuration collocates with suitable operation waveforms (as that shown in FIG. 3/FIG. 9), the current I_{OLED} flowing through the OLED 101/701 is not changed along with the power supply voltage Vdd which may be influenced by the IR drop, and is not varied along with the threshold voltage (Vth) shift of the driving transistor T1 used for driving the OLED 101/701. Accordingly, the brightness performance of the applied OLED display is substantially improved. Besides, any OLED display panel applying the (OLED) pixel circuit 10/70 of the aforementioned exemplary embodiments and the OLED display thereof are considered to be within a protection scope of the invention.

Moreover, although the OLED pixel circuit of the aforementioned exemplary embodiments uses the P-type transistors for implementation, the invention is not limited thereto. In other words, those skilled in the art can deduce a variation pattern that the OLED pixel circuit uses the N-type transistors for implementation according to teachings of the aforementioned exemplary embodiments without departing from the spirit and scope of the present invention, and the variations are also within the protection scope of the invention.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A light-emitting component driving circuit, comprising:
a power unit, receiving a power supply voltage, and conducting the power supply voltage in response to a light enable signal in a light enable phase;
a driving unit, coupled between the power unit and a light-emitting component, comprising a driving transistor coupled to a first end of the light-emitting component, and controlling a driving current flowing through the light-emitting component in the light enable phase, wherein a second end of the light-emitting component receives the light enable signal; and
a data storage unit, comprising a storage capacitor, configured to store a data voltage and a threshold voltage related to the driving transistor through the storage capacitor in a data-writing phase,
wherein in the light enable phase, the driving unit generates the driving current flowing through the light-emitting component in response to a cross-voltage of the storage capacitor, and the driving current is not influenced by the threshold voltage of the driving transistor.

2. The light-emitting component driving circuit as claimed in claim 1, wherein the power unit comprises:
a power conduction transistor, having a source receiving the power supply voltage, and a gate receiving the light enable signal,
wherein a first drain/source of the driving transistor is coupled to a drain of the power conduction transistor, a second drain/source of the driving transistor is coupled to the first end of the light-emitting component, and a gate of the driving transistor is coupled to a first end of the storage capacitor.

3. The light-emitting component driving circuit as claimed in claim 2, wherein the data storage unit further comprises:
a writing transistor, having a gate receiving a writing scan signal, a drain receiving the data voltage, and a source coupled to the second drain/source of the driving transistor and the first end of the light-emitting component; and
a collection transistor, having a gate receiving the writing scan signal, a source coupled to the gate of the driving transistor and the first end of the storage capacitor, and a drain coupled to the first drain/source of the driving transistor and the drain of the power conduction transistor,
wherein the light-emitting component is an organic light-emitting diode, and the first end of the light-emitting component is an anode of the organic light-emitting diode, and the second end of the light-emitting component is a cathode of the organic light-emitting diode.

4. The light-emitting component driving circuit as claimed in claim 3, wherein the data storage unit initializes the storage capacitor in response to a reset scan signal in a reset phase, and the data storage unit further comprises:
a reset transistor, having a gate coupled to a source thereof to receive the reset scan signal, and a drain coupled to the gate of the driving transistor, the source of the collection transistor and the first end of the storage capacitor,
wherein the driving transistor, the power conduction transistor, the writing transistor, the collection transistor and the reset transistor are all P-type transistors.

5. The light-emitting component driving circuit as claimed in claim 4, wherein the light-emitting component driving circuit is an organic light-emitting diode driving circuit, and the organic light-emitting diode driving circuit sequentially enters the reset phase, the data-writing phase and the light enable phase,
wherein in the reset phase, the reset scan signal is enabled, and the writing scan signal and the light enable signal are disabled; in the data-writing phase, the writing scan signal is enabled, and the reset scan signal and the light enable signal are disabled; and in the light enable phase, the light enable signal is enabled, and the reset scan signal and the writing scan signal are disabled.

6. The light-emitting component driving circuit as claimed in claim 5, wherein a second end of the storage capacitor is coupled to the power supply voltage.

7. The light-emitting component driving circuit as claimed in claim 5, wherein a second end of the storage capacitor is coupled to a reference voltage.

8. The light-emitting component driving circuit as claimed in claim 2, wherein the data storage unit further comprises:
a writing transistor, having a gate receiving a writing scan signal, a drain receiving the data voltage, and a source coupled to the first drain/source of the driving transistor and the drain of the power conduction transistor; and
a collection transistor, having a gate receiving the writing scan signal, a source coupled to the gate of the driving transistor and the first end of the storage capacitor, and a drain coupled to the second drain/source of the driving transistor and the first end of the light-emitting component,
wherein the light-emitting component is an organic light-emitting diode, and the first end of the light-emitting component is an anode of the organic light-emitting diode, and the second end of the light-emitting component is a cathode of the organic light-emitting diode.

9. The light-emitting component driving circuit as claimed in claim 8, wherein the data storage unit initializes the storage capacitor in response to a reset scan signal in a reset phase, and the data storage unit further comprises:
a reset transistor, having a gate coupled to a source thereof to receive the reset scan signal, and a drain coupled to the gate of the driving transistor, the source of the collection transistor and the first end of the storage capacitor,
wherein the driving transistor, the power conduction transistor, the writing transistor, the collection transistor and the reset transistor are all P-type transistors.

10. The light-emitting component driving circuit as claimed in claim 9, wherein the light-emitting component driving circuit is an organic light-emitting diode driving circuit, and the organic light-emitting diode driving circuit sequentially enters the reset phase, the data-writing phase and the light enable phase,
wherein in the reset phase, the reset scan signal is enabled, and the writing scan signal and the light enable signal are disabled; in the data-writing phase, the writing scan signal is enabled, and the reset scan signal and the light enable signal are disabled; and in the light enable phase, the light enable signal is enabled, and the reset scan signal and the writing scan signal are disabled.

11. The light-emitting component driving circuit as claimed in claim 10, wherein a second end of the storage capacitor is coupled to the power supply voltage.

12. The light-emitting component driving circuit as claimed in claim 10, wherein a second end of the storage capacitor is coupled to a reference voltage.

13. A pixel circuit, comprising:
a light-emitting component, lighting in response to a driving current in a light enable phase;
a power unit, receiving a power supply voltage, and conducting the power supply voltage in response to a light enable signal in the light enable phase;
a driving unit, coupled between the power unit and a first end of the light-emitting component, comprising a driving transistor coupled to the first end of the light-emitting component, and controlling the driving current flowing through the light-emitting component in the light enable phase, wherein a second end of the light-emitting component receives the light enable signal; and
a data storage unit, comprising a storage capacitor, configured to store a data voltage and a threshold voltage related to the driving transistor through the storage capacitor in a data-writing phase,
wherein in the light enable phase, the driving unit generates the driving current flowing through the light-emitting component in response to a cross-voltage of the storage capacitor, and the driving current is not influenced by the threshold voltage of the driving transistor.

14. The pixel circuit as claimed in claim 13, wherein the power unit comprises:
a power conduction transistor, having a source receiving the power supply voltage, and a gate receiving the light enable signal,
wherein a first drain/source of the driving transistor is coupled to a drain of the power conduction transistor, a second drain/source of the driving transistor is coupled to the first end of the light-emitting component, and a gate of the driving transistor is coupled to a first end of the storage capacitor,
wherein a second end of the storage capacitor is coupled to one of the power supply voltage and a reference voltage.

15. The pixel circuit as claimed in claim 14, wherein the data storage unit further comprises:
a writing transistor, having a gate receiving a writing scan signal, a drain receiving the data voltage, and a source coupled to the second drain/source of the driving transistor and the first end of the light-emitting component; and
a collection transistor, having a gate receiving the writing scan signal, a source coupled to the gate of the driving transistor and the first end of the storage capacitor, and a drain coupled to the first drain/source of the driving transistor and the drain of the power conduction transistor,
wherein the light-emitting component is an organic light-emitting diode, and the first end of the light-emitting component is an anode of the organic light-emitting diode, and the second end of the light-emitting component is a cathode of the organic light-emitting diode.

16. The pixel circuit as claimed in claim 15, wherein the data storage unit initializes the storage capacitor in response to a reset scan signal in a reset phase, and the data storage unit further comprises:
a reset transistor, having a gate coupled to a source thereof to receive the reset scan signal, and a drain coupled to the gate of the driving transistor, the source of the collection transistor and the first end of the storage capacitor,
wherein the driving transistor, the power conduction transistor, the writing transistor, the collection transistor and the reset transistor are all P-type transistors.

17. The pixel circuit as claimed in claim 14, wherein the data storage unit further comprises:
a writing transistor, having a gate receiving a writing scan signal, a drain receiving the data voltage, and a source coupled to the first drain/source of the driving transistor and the drain of the power conduction transistor; and
a collection transistor, having a gate receiving the writing scan signal, a source coupled to the gate of the driving transistor and the first end of the storage capacitor, and a drain coupled to the second drain/source of the driving transistor and the first end of the light-emitting component,
wherein the light-emitting component is an organic light-emitting diode, and the first end of the light-emitting component is an anode of the organic light-emitting diode, and the second end of the light-emitting component is a cathode of the organic light-emitting diode.

18. The pixel circuit as claimed in claim 17, wherein the data storage unit initializes the storage capacitor in response to a reset scan signal in a reset phase, and the data storage unit further comprises:
a reset transistor, having a gate coupled to a source thereof to receive the reset scan signal, and a drain coupled to the gate of the driving transistor, the source of the collection transistor and the first end of the storage capacitor,
wherein the driving transistor, the power conduction transistor, the writing transistor, the collection transistor and the reset transistor are all P-type transistors.

19. The pixel circuit as claimed in claim 13, wherein the pixel circuit is an organic light-emitting diode pixel circuit.

20. An organic light-emitting diode display panel having the pixel circuit as claimed in claim 19.

21. An organic light-emitting diode display having the organic light-emitting diode display panel as claimed in claim 20.

22. A light-emitting component driving circuit, comprising:
a power unit, receiving a power supply voltage, and conducting the power supply voltage in response to a light enable signal in a light enable phase;
a driving unit, coupled between the power unit and a light-emitting component, comprising a driving transistor coupled to a first end of the light-emitting component, and controlling a driving current flowing through the light-emitting component in the light enable phase; and
a data storage unit, comprising a storage capacitor, configured to store a data voltage and a threshold voltage related to the driving transistor through the storage capacitor in a data-writing phase,
wherein in the light enable phase, the driving unit generates the driving current flowing through the light-emitting component in response to a cross-voltage of the storage capacitor,
wherein the driving current is not influenced by the threshold voltage of the driving transistor, and an impact of the power supply voltage on the driving current is mitigated.

23. The light-emitting component driving circuit as claimed in claim 22, wherein a second end of the light-emitting component is coupled to a fixed reference voltage, the power supply voltage is a fixed power supply voltage, and the power unit comprises:
a power conduction transistor, having a source receiving the fixed power supply voltage, and a gate receiving the light enable signal.

24. The light-emitting component driving circuit as claimed in claim 23, wherein:
a first drain/source of the driving transistor is coupled to a drain of the power conduction transistor, a second drain/source of the driving transistor is coupled to the first end of the light-emitting component, and a gate of the driving transistor is coupled to a first end of the storage capacitor; and
a second end of the storage capacitor is coupled to a control signal.

25. The light-emitting component driving circuit as claimed in claim 24, wherein the data storage unit further comprises:
a writing transistor, having a gate receiving a writing scan signal, a drain receiving the data voltage, and a source coupled to the second drain/source of the driving transistor and the first end of the light-emitting component; and
a collection transistor, having a gate receiving the writing scan signal, a source coupled to the gate of the driving transistor and the first end of the storage capacitor, and a drain coupled to the first drain/source of the driving transistor and the drain of the power conduction transistor,
wherein the light-emitting component is an organic light-emitting diode, and the first end of the light-emitting component is an anode of the organic light-emitting diode, and the second end of the light-emitting component is a cathode of the organic light-emitting diode,
wherein a level of the fixed reference voltage is substantially not less than a highest level of the data voltage minus a conduction voltage of the organic light-emitting diode.

26. The light-emitting component driving circuit as claimed in claim 25, wherein the data storage unit initializes the storage capacitor in response to a reset scan signal in a reset phase.

27. The light-emitting component driving circuit as claimed in claim 26, wherein the data storage unit further comprises:
a reset transistor, having a gate coupled to a source thereof to receive the reset scan signal, and a drain coupled to the gate of the driving transistor, the source of the collection transistor and the first end of the storage capacitor.

28. The light-emitting component driving circuit as claimed in claim 27, wherein the driving transistor, the power conduction transistor, the writing transistor, the collection transistor and the reset transistor are all P-type transistors.

29. The light-emitting component driving circuit as claimed in claim 28, wherein the light-emitting component driving circuit is an organic light-emitting diode driving circuit, and the organic light-emitting diode driving circuit sequentially enters the reset phase, the data-writing phase and the light enable phase.

30. The light-emitting component driving circuit as claimed in claim 29, wherein:
in the reset phase and the data-writing phase, the control signal has a first low voltage level; and
in the light enable phase, the control signal has a high voltage level.

31. The light-emitting component driving circuit as claimed in claim 30, wherein:
in the reset phase and the data-writing phase, the light enable signal has the high voltage level; and
in the light enable phase, the light enable signal has a second low voltage level which is different from the first low voltage level.

32. The light-emitting component driving circuit as claimed in claim 31, wherein:
in the reset phase, the reset scan signal has the second low voltage level; and
in the data-writing phase and the light enable phase, the reset scan signal has the high voltage level.

33. The light-emitting component driving circuit as claimed in claim 32, wherein:
in the data-writing phase, the writing scan signal has the second low voltage level; and
in the reset phase and the light enable phase, the writing scan signal has the high voltage level.

34. The light-emitting component driving circuit as claimed in claim 24, wherein the data storage unit further comprises:
a writing transistor, having a gate receiving a writing scan signal, a drain receiving the data voltage, and a source coupled to the first drain/source of the driving transistor and the drain of the power conduction transistor; and
a collection transistor, having a gate receiving the writing scan signal, a source coupled to the gate of the driving transistor and the first end of the storage capacitor, and a drain coupled to the second drain/source of the driving transistor and the first end of the light-emitting component,
wherein the light-emitting component is an organic light-emitting diode, and the first end of the light-emitting component is an anode of the organic light-emitting diode, and the second end of the light-emitting component is a cathode of the organic light-emitting diode,
wherein a level of the fixed reference voltage is substantially not less than a highest level of the data voltage minus the threshold voltage of the driving transistor and a conduction voltage of the organic light-emitting diode.

35. The light-emitting component driving circuit as claimed in claim 34, wherein the data storage unit initializes the storage capacitor in response to a reset scan signal in a reset phase.

36. The light-emitting component driving circuit as claimed in claim 35, wherein the data storage unit further comprises:
a reset transistor, having a gate coupled to a source thereof to receive the reset scan signal, and a drain coupled to the gate of the driving transistor, the source of the collection transistor and the first end of the storage capacitor.

37. The light-emitting component driving circuit as claimed in claim 36, wherein the driving transistor, the power conduction transistor, the writing transistor, the collection transistor and the reset transistor are all P-type transistors.

38. The light-emitting component driving circuit as claimed in claim 37, wherein the light-emitting component driving circuit is an organic light-emitting diode driving circuit, and the organic light-emitting diode driving circuit sequentially enters the reset phase, the data-writing phase and the light enable phase.

39. The light-emitting component driving circuit as claimed in claim 38, wherein:
in the reset phase and the data-writing phase, the control signal has a first low voltage level; and
in the light enable phase, the control signal has a high voltage level.

40. The light-emitting component driving circuit as claimed in claim 39, wherein:
in the reset phase and the data-writing phase, the light enable signal has the high voltage level; and
in the light enable phase, the light enable signal has a second low voltage level which is different from the first low voltage level.

41. The light-emitting component driving circuit as claimed in claim 40, wherein:
in the reset phase, the reset scan signal has the second low voltage level; and
in the data-writing phase and the light enable phase, the reset scan signal has the high voltage level.

42. The light-emitting component driving circuit as claimed in claim 41, wherein:
in the data-writing phase, the writing scan signal has the second low voltage level; and
in the reset phase and the light enable phase, the writing scan signal has the high voltage level.

43. A pixel circuit, comprising:
a light-emitting component, lighting in response to a driving current in a light enable phase;
a power unit, receiving a power supply voltage, and conducting the power supply voltage in response to a light enable signal in a light enable phase;
a driving unit, coupled between the power unit and the light-emitting component, comprising a driving transistor coupled to a first end of the light-emitting component, and controlling a driving current flowing through the light-emitting component in the light enable phase; and
a data storage unit, comprising a storage capacitor, configured to store a data voltage and a threshold voltage related to the driving transistor through the storage capacitor in a data-writing phase,
wherein in the light enable phase, the driving unit generates the driving current flowing through the light-emitting component in response to a cross-voltage of the storage capacitor,
wherein the driving current is not influenced by the threshold voltage of the driving transistor, and an impact of the power supply voltage on the driving current is mitigated.

44. The pixel circuit as claimed in claim 43, wherein:
a second end of the light-emitting component is coupled to a fixed reference voltage, the power supply voltage is a fixed power supply voltage;
the power unit comprises a power conduction transistor, having a source receiving the fixed power supply voltage, and a gate receiving the light enable signal;
a first drain/source of the driving transistor is coupled to a drain of the power conduction transistor, a second drain/source of the driving transistor is coupled to the first end of the light-emitting component, and a gate of the driving transistor is coupled to a first end of the storage capacitor; and
a second end of the storage capacitor is coupled to a control signal.

45. The pixel circuit as claimed in claim 44, wherein the data storage unit further comprises:
a writing transistor, having a gate receiving a writing scan signal, a drain receiving the data voltage, and a source coupled to the second drain/source of the driving transistor and the first end of the light-emitting component; and
a collection transistor, having a gate receiving the writing scan signal, a source coupled to the gate of the driving transistor and the first end of the storage capacitor, and a drain coupled to the first drain/source of the driving transistor and the drain of the power conduction transistor,
wherein the light-emitting component is an organic light-emitting diode, and the first end of the light-emitting component is an anode of the organic light-emitting diode, and the second end of the light-emitting component is a cathode of the organic light-emitting diode,
wherein a level of the fixed reference voltage is substantially not less than a highest level of the data voltage minus a conduction voltage of the organic light-emitting diode.

46. The pixel circuit as claimed in claim 45, wherein the data storage unit initializes the storage capacitor in response to a reset scan signal in a reset phase,
wherein the data storage unit further comprises a reset transistor, having a gate coupled to a source thereof to receive the reset scan signal, and a drain coupled to the gate of the driving transistor, the source of the collection transistor and the first end of the storage capacitor,
wherein the driving transistor, the power conduction transistor, the writing transistor, the collection transistor and the reset transistor are all P-type transistors.

47. The pixel circuit as claimed in claim 44, wherein the data storage unit further comprises:
a writing transistor, having a gate receiving a writing scan signal, a drain receiving the data voltage, and a source coupled to the first drain/source of the driving transistor and the drain of the power conduction transistor; and
a collection transistor, having a gate receiving the writing scan signal, a source coupled to the gate of the driving transistor and the first end of the storage capacitor, and a drain coupled to the second drain/source of the driving transistor and the first end of the light-emitting component,
wherein the light-emitting component is an organic light-emitting diode, and the first end of the light-emitting component is an anode of the organic light-emitting diode, and the second end of the light-emitting component is a cathode of the organic light-emitting diode,
wherein a level of the fixed reference voltage is substantially not less than a highest level of the data voltage minus the threshold voltage of the driving transistor and a conduction voltage of the organic light-emitting diode.

48. The pixel circuit as claimed in claim 47, wherein the data storage unit initializes the storage capacitor in response to a reset scan signal in a reset phase,
wherein the data storage unit further comprises a reset transistor, having a gate coupled to a source thereof to receive the reset scan signal, and a drain coupled to the gate of the driving transistor, the source of the collection transistor and the first end of the storage capacitor,
wherein the driving transistor, the power conduction transistor, the writing transistor, the collection transistor and the reset transistor are all P-type transistors.

49. The pixel circuit as claimed in claim 44, wherein the driving unit, the power unit, the driving unit and the data storage unit form an organic light-emitting diode driving circuit, and the organic light-emitting diode driving circuit sequentially enters the reset phase, the data-writing phase, and the light enable phase,
wherein the control signal has a first low voltage level in the reset phase and the data-writing phase, and the control signal has a high voltage level in the light enable phase,
wherein the light enable signal has the high voltage level in the reset phase and the data-writing phase, and the light enable signal has a second low voltage level which is different from the first low voltage level in the light enable phase,
wherein the reset scan signal has the second low voltage level in the reset phase, and the reset scan signal has the high voltage level in the data-writing phase and the light enable phase,
wherein the writing scan signal has the second low voltage level in the data-writing phase, and the writing scan signal has the high voltage level in the reset phase and the light enable phase.

50. An organic light-emitting diode display panel having the pixel circuit as claimed in claim 43.

51. An organic light-emitting diode display having the organic light-emitting diode display panel as claimed in claim 50.
